(19) United States
(12) Patent Application Publication
(10) Pub. No.: US 2007/0158956 A1
(43) Pub. Date: Jul. 12, 2007

(54) Pressurized handle set

(75) Inventors: Shih-Ming Wang, Taipei (TW); Jo-Shun Chiang, Jhongli City (TW)

Correspondence Address: TROXELL LAW OFFICE PLLC, SUITE 1404, 5205 LEESBURG PIKE, FALLS CHURCH, VA, 22041, US

(73) Assignees: Jui Hung Refrigeration Technology Co., Ltd.; Chung Yuan Christian University

(21) Appl. No.: 11/580,308

(22) Filed: Oct. 13, 2006

(30) Foreign Application Priority Data
Oct. 28, 2005 (TW) 94137758

(51) Int. Cl. E05C 3/02

(52) U.S. Cl. 292/240

(57) ABSTRACT

A pressurized handle set includes a latch member, a sliding slot and a door set. The door set includes a door, a door frame, a pliable pad and a bolt. The bolt couples the door and door frame and provides a turning means. The pliable pad is interposed between the door and door frame. The latch member and the sliding slot are located on respectively on the door and door frame. The latch member includes an axle, a bracing arm and a stub shaft. The bracing arm may turn about the axle along a swivel path. The stub shaft is located on one end of the bracing arm. When the bracing arm is swiveled along the swivel path and slid in a distal end of the sliding slot, the pliable pad is compressed to generate an elastic force. The sliding slot thus structured can gradually increase the elastic force then gradually decrease the elastic force.

### BACKGROUND OF THE INVENTION

1. Field of the Invention

The present invention relates to a door handle and particularly to a pressurized handle set.

2. Description of the Prior Art

Refrigeration equipment usually has a pliable pad interposed between the door and door frame to enable the door to be sealed tightly without causing gas leakage. During closing of the door, the pliable pad is compressed to form an airtight sealing between the door and door frame. Hence a pressurized handle is usually required to generate a pressure on the door during closing to compress the pliable pad and form a secure closing of the door.

Refer to FIG. 1 for a conventional pressurized handle set. It includes a pressurized handle 2, an axle 4 and a latch member 6. The pressurized handle 2 is mounted onto the axle 4 and swivels about thereof. When the pressurized handle 2 is swiveled in the latch member 6, it is moved from an outer and lower extended position 3 to a upper position 5 to form a pressurized displacement.

Such a pressurized handle usually closes the door by compressing. It loosens easily. Moreover, the refrigeration door and door frame are prone to stick together due to frosting. Hence it takes a great effort to open the door. As a result, an additional design often is needed to prevent the pressurized handle from loosening and make separation of the door and door frame easier.

### SUMMARY OF THE INVENTION

In view of the aforesaid problems occurred to the conventional pressurized handle set, the present invention aims to provide an improved pressurized handle set that has a stub shaft or rotary wheel sliding in a sliding slot and is moved based on the levering principle so that during the stub shaft or rotary wheel is sliding in the sliding slot the distance between the pressurized handle and the sliding slot decreases. In addition, the sliding slot is formed in shape such that while the stub shaft or rotary wheel slides in the sliding slot, the pressurized handle initially moves closer to the sliding slot, then moves slightly away. Thus, in the sliding process of the stub shaft or rotary wheel in the sliding slot, a pliable pad between the handle and the sliding slot is compressed to generate an elastic force which increases gradually first, then gradually decreases. Thereby an additional external force is needed to move the stub shaft or rotary wheel away from the sliding slot. As a result, the stub shaft or rotary wheel can be latched securely in the sliding slot. Moreover, while the stub shaft or rotary wheel is sliding out of the sliding slot, it rams the sliding slot and can separate the door and door frame easier based on the levering principle.

The foregoing, as well as additional objects, features and advantages of the invention will be more readily apparent from the following detailed description, which proceeds with reference to the accompanying drawings. The embodiments depicted below serve only illustrative purpose, and are not the limitation of the invention. The scope of the invention shall be covered by the claims listed hereinafter.

### BRIEF DESCRIPTION OF THE DRAWINGS

FIG. 1 is a schematic view of a conventional pressurized handle set;

FIGS. 2A through 2D are perspective views of an embodiment of the invention in operating conditions for latching the latch member in the sliding slot;

FIGS. 3A and 3B are schematic views of an embodiment of the invention in operating conditions for moving the latch member away from the sliding slot;

FIGS. 4A and 4B are perspective views of an embodiment of the invention adopted on a door set; and

FIG. 5 is a schematic view of another embodiment of the invention with a plurality of arches forming on the sliding slot.

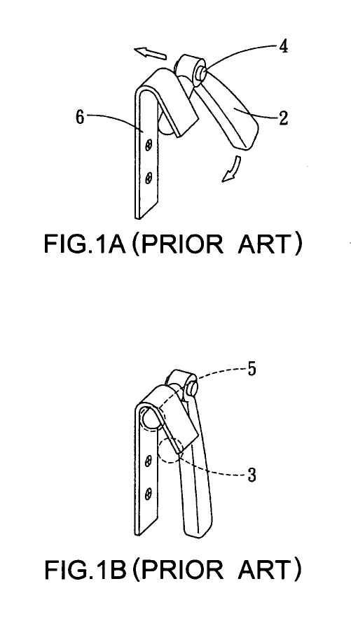

### DESCRIPTION OF THE PREFERRED EMBODIMENTS

The pressurized handle set according to the invention includes a latch member, a sliding slot and a door set. The door set includes a door, a door frame, a pliable pad and a bolt. The bolt couples the door and door frame and provides a turning function. The pliable pad is interposed between the door and door frame. The latch member and the sliding slot are located on respectively on the door and door frame. The latch member has an axle, a bracing arm and a stub shaft. The bracing arm can turn about the axle along a swivel path. The stub shaft is located on one end of the bracing arm. While the bracing arm is turned along the swivel path to a distal end of the sliding slot, the pliable pad is compressed and generates an elastic force. The sliding slot thus structured enables the elastic force to increase gradually then decrease gradually.

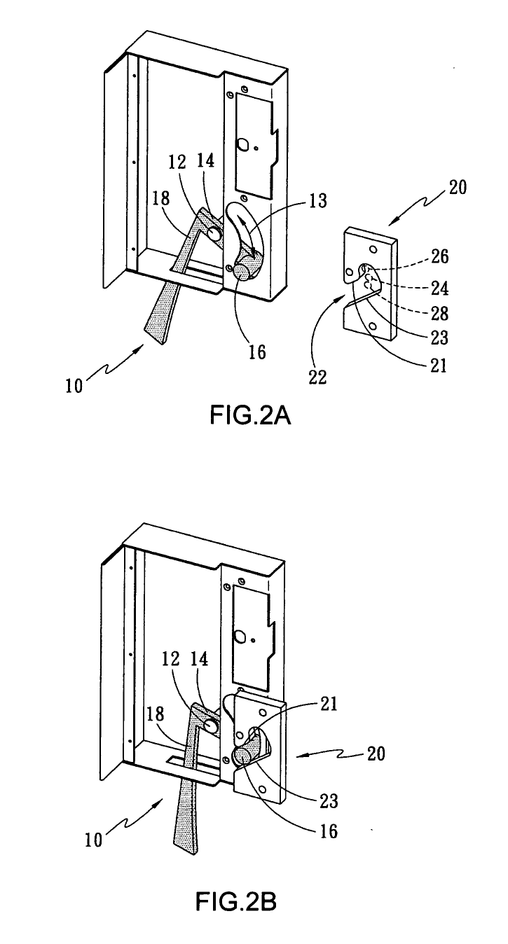

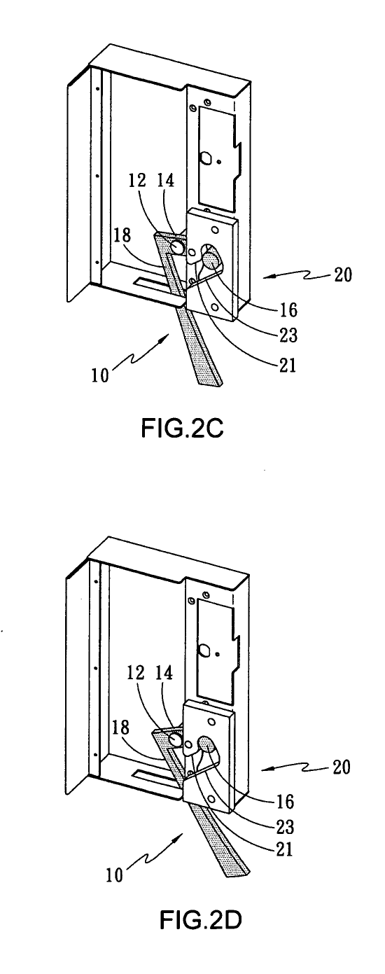

Refer to FIGS. 2A through 2D for an embodiment of the invention in operating conditions. The invention includes a latch member 10 and a sliding slot 20. The latch member 10 includes an axle 12, a bracing arm 14 and a stub shaft 16. The bracing arm 14 can turn about the axle 12 and swivel along a swivel path 13. The stub shaft 16 is mounted onto the bracing arm 14, preferably on one end of the bracing arm 14. The sliding slot 20 is formed in an arched structure, and has an opening 22, a first position 24 and a second position 26. The stub shaft 16 is moved, following the swivel path, from the opening 22, passing through the first position 24, to the second position 26.

While the stub shaft 16 is moved to the first position 24 and the second position 26, the distance between the axle 12 and opening 22 is respectively a first distance and a second distance (not shown in the drawings). The first distance is smaller than the second distance based on the axle 12. For instance, compared with the first position 24, the second position 26 is closer to the axle 12. Thus while the stub shaft 16 is moved from the opening 22, passing through the first position 24, to the second position 26, the axle 12 first moves closer to the opening 22, then moves away.

When the stub shaft 16 is moved to the second position 26, through a force which moves the latch member 10 from the sliding slot 20, the stub shaft 16 may be anchored on the second position 26. A buffer means, such as an elastic material, may be added between the latch member 10 (such as the axle 12) and the sliding slot 20. Thereby when the latch member 10 is moved close to the sliding slot 20, the buffer means is compressed to generate an elastic force. Namely, the buffer means provides a displacement control for the latch member 10 (or axle 12). Presumed that the elastic forces of the stub shaft 16 at the first position 24 and the second position 26 are respectively a first elastic force and a second elastic force, then the first elastic force is greater than the second elastic force. Hence when the stub shaft 16 is moved to the second position 26, it is harnessed by the second elastic force and latched on the second position 26. A force greater than or equal to the first elastic force is needed to move the stub shaft 16 from the second position 26, passing through the first position 24, to escape the sliding slot 20.

In addition, the sliding slot 20 may include a third position 28. When the stub shaft 16 is moved to the third position 28, a third elastic force is generated which is the greatest among the elastic forces related to the sliding slot 20. In the structure set forth above, the swivel path 13 of the stub shaft 16 starts from the third position 28, and passes through the first position 24 to the second position 26. Namely, with the first position 24, second position 26 and third position 28 at the same arched structure, the third position 28 spaces from the latch member 10 at the greatest distance. Hence to move the stub shaft 16 to the second position 26, a force greater than or equal to the third elastic force is needed to enable the stub shaft 16 to pass through the third position 28 and enter the second position 26. On the other hand, a force greater than or equal to the third elastic force is needed to move the stub shaft 16 from the second position 26, and pass through the first position 24 and third position 28 to escape the sliding slot 20.

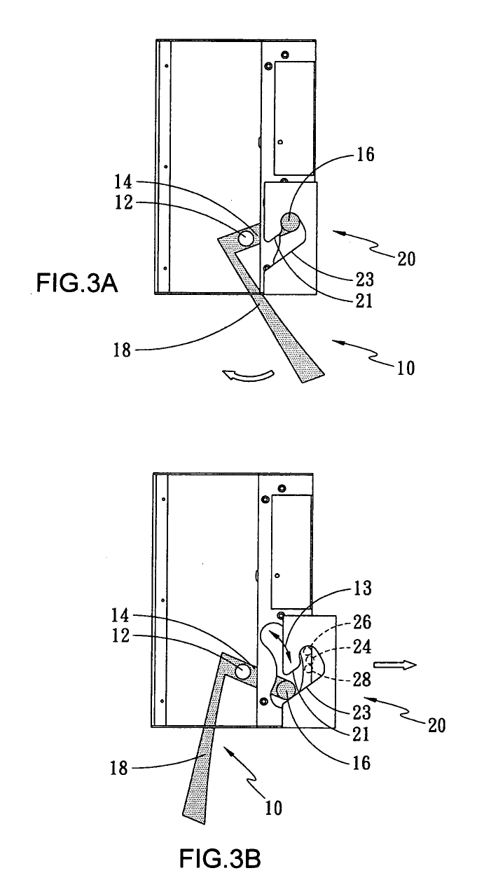

Referring to FIGS. 2A through 2D, when the latch member 10 is coupled with the sliding slot 20, the stub shaft 16 moves from a first side 21 of the sliding slot 20, passing through the third position 28 and the first position 24, to the second position 26. On the other hand, referring to FIGS. 3A and 3B, when the latch member 10 escapes from the sliding slot 20, the stub shaft 16 moves from the second position 26, passes through the first position 24 and third position 28, and slides to a second side 23 of the sliding slot 20 to exit the sliding slot 20. The second side 23 in contact with the stub shaft may be a straight structure rather than an arched structure to make sliding out of the latch member 10 from the sliding slot 20 easier.

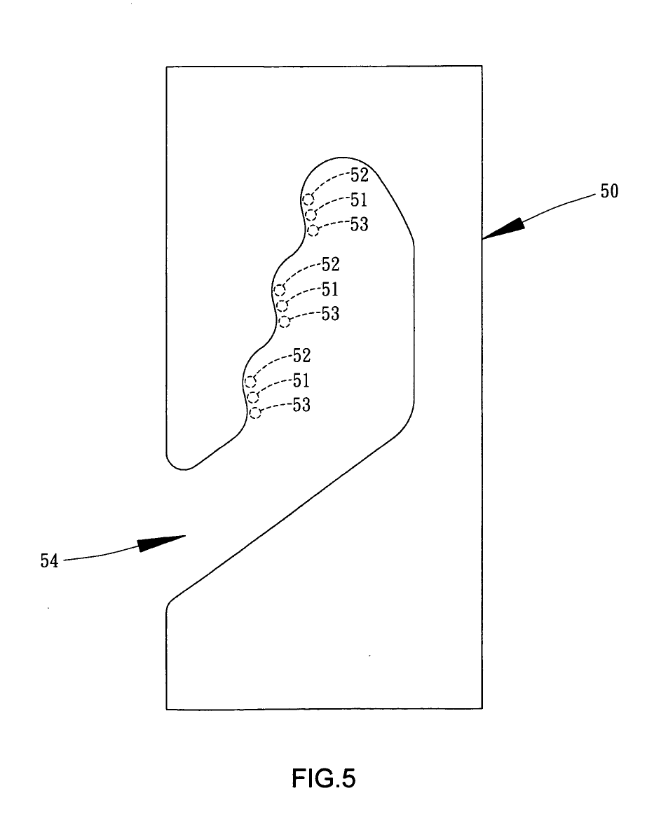

Aside from the embodiment of the sliding slot set forth above, other embodiments may be adopted, such as a structure consisting of a plurality of arched structures to provide adjustment with different distances between the latch member and the sliding slot. FIG. 5 illustrates another embodiment in which a sliding slot 50 has consecutive arched structures. Each arched structure has a first position 51, a second position 52 and a third position 53. Therefore, when the stub shaft slides into the sliding slot 20 through the opening, it can be selectively latched on the second position 52 of different arched structures to adjust the distance between the latch member and the sliding slot, and also form different compression to the buffer means to generate different elastic force to achieve a secure coupling of two objects.

In addition, the latch member 10 in this embodiment may further include a turning means 18 located on another end of the bracing arm 14 opposing the stub shaft 16 to drive the bracing arm 14 to swivel. The turning means 18 may be formed in an elongated shape, an arched shape or a wheel shape to facilitate driving of the bracing arm. In this embodiment, the turning means 18 is an elongated lever. Moreover, the stub shaft 16 may be formed in other types desired (such as a rotary wheel, not shown in the drawings) to facilitate sliding of the stub shaft in the sliding slot.

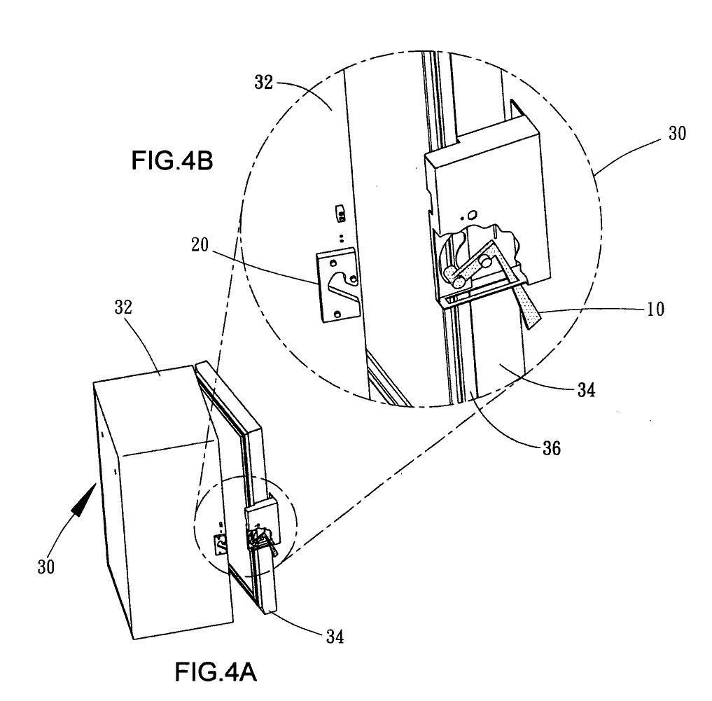

Refer to FIGS. 4A and 4B for a second embodiment of the invention. It is a handle set including a latch member 10, a sliding slot 20 and a door set 30. The door set 30 includes a door 34, a door frame 32, a pliable pad 36 (such as the buffer means previously discussed) and a bolt (not shown in the drawings). The bolt couples the door 34 and the door frame 32 and provides a turning means. The pliable pad 36 is interposed between the door 34 and the door frame 32. The latch member 10 and the sliding slot 20 are located respectively on the door 34 and door frame 32. In this embodiment, the latch member 10 and the sliding slot 20 are located respectively on the door 34 and the door frame 32.

Furthermore, a lock may be added so that when the stub shaft of the latch member is located on the second position, the latch member can be locked without escaping the sliding slot.

In short, the pressurized handle set according to the invention can securely latch the latch member through the second elastic force without loosening easily. Through the bracing arm, the latch member can be slid away from the sliding slot to separate the door and door frame.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

I claim:

1. A pressurized handle set to couple and separate two objects, comprising:
a latch member which is located on one object and includes an axle, a bracing arm and a stub shaft, the stub shaft being located on one end of the bracing arm, the bracing arm being swivelable about the axle along a swivel path; and
a sliding slot which is located on another object and has at least one arched structure, the arched structure having an opening, a first position and a second position;
wherein the stub shaft is movable along the swivel path from the opening through the first position where the axle is spaced from the opening at a first distance to the second position where the axle is spaced from the opening at a second distance, the first distance being smaller than the second distance such that when the two objects are coupled the sliding slot gradually moves closer to the latch member then moves away, and when the two objects are separated the sliding slot moves closer to the latch member then moves away.

2. The pressurized handle set of claim 1 further having a buffer means interposed between the axle and the sliding slot to be compressed to generate an elastic force when the stub shaft is moved in the sliding slot.

3. The pressurized handle set of claim 2, wherein the elastic force is a first elastic force when the stub shaft is at the first position, and the elastic force is a second elastic force when the stub shaft is at the second position, the first elastic force being greater than the second elastic force.

4. The pressurized handle set of claim 1 further having a turning means located on another end of the bracing arm opposing the stub shaft to drive the bracing arm to swivel.

5. The pressurized handle set of claim 1, wherein the arched structure of the sliding slot has a third position, the stub shaft being swiveled along the swivel path to pass through the opening, the third position and the first position to be latched on the second position.

6. The pressurized handle set of claim 5, wherein the stub shaft generates a third elastic force during locating at the third position, the third elastic force is generated which is the greatest among the elastic forces related to the sliding slot.

7. The pressurized handle set of claim 5, wherein the sliding slot has a plurality of arched structures, each of the arched structures having a first position, a second position and a third position.

8. The pressurized handle set of claim 1, wherein the stub shaft is a rotary wheel.

9. The pressurized handle set of claim 1, wherein the two objects are a door and a door frame.

10. The pressurized handle set of claim 9, wherein the buffer means is located between the door and the door frame.

11. The pressurized handle set of claim 10, wherein the buffer means is a pliable pad.
